(19) United States
(12) Patent Application Publication
(10) Pub. No.: US 2011/0027770 A1
(43) Pub. Date: Feb. 3, 2011

(54) READER DEVICES AND RELATED HOUSINGS AND ACCESSORIES AND METHODS OF USING SAME

(75) Inventors: Moshe Cohen, Tel Aviv (IL); Yossef Raichman, Herzlia (IL)

Correspondence Address: MARTIN D. MOYNIHAN d/b/a PRTSI, INC., P.O. BOX 16446, ARLINGTON, VA, 22215, US

(73) Assignee: In-Dot Ltd., Tel-Aviv (IL)

(21) Appl. No.: 12/936,217

(22) PCT Filed: Apr. 5, 2009
(86) PCT No.: PCT/IL09/00378

§ 371 Date: Oct. 4, 2010

Related U.S. Application Data
(60) Provisional application No. 61/071,041, filed on Apr. 9, 2008.

(30) Foreign Application Priority Data
Jan. 8, 2009 (IL) PCT/IL2009/000030

(51) Int. Cl. G09B 7/00; G06K 7/01; A63F 9/24

(52) U.S. Cl. 434/362; 235/375; 463/46

(57) ABSTRACT

A system for presenting multimedia content, comprising: a reader device; at least one of a reader device housing or reader device accessory removably attached to the reader device; and, at least one multimedia content enhanced object with at least one multimedia content indicator; wherein the reader device adapts its operation based on an identification of the at least one reader device housing or reader device accessory removably attached thereto.

### FIELD OF THE INVENTION

The present invention relates to adding at least one interactive layer to printed media and, more particularly, but not exclusively to providing at least one content-related housing and/or accessory to a reader device which is used for identifying a label in a printed publication, such as a book, and presenting multimedia content in response.

### BACKGROUND OF THE INVENTION

Devices that add an interactive layer to printed publications, such as books and comic magazines, are known. Coded labels, which are adhered to the printed publication, allow users to gain added enjoyment by playing phrases spoken by popular characters, sound effects, or game ideas, which are related to a section of the printed publication.

An example for such a device is a reader that allows users to scan barcodes, which are printed in the proximity of a certain text, and play a related audio file in response. Such a device has a limited applicability, as it may be difficult to teach little children to perform the scanning along the barcodes. In addition, such a reader uses a laser based reading head that may be hazardous for little children and youngsters, because it may cause undesired eye exposure to the emitted laser. Such an exposure may cause retinal damage if it lasts for more then several seconds.

U.S. patent application Ser. No. 2006/0259314, the disclosure of which is incorporated herein by reference, describes a reading device having a handle or grabbing surface, a label identification head and means for outputting an audio sequence corresponding to each label that is identified. The label has bi-dimensional distinguishing features. The identification head includes a bi-dimensional sensor array that is adapted to read the distinguishing features in the label without scanning, when the device is placed over the label. The reading device comprises a handle for easy and ergonomic grabbing by a child's hand, an identification head located in the lower part of the device, for identifying each label when the identification head is placed over the label without scanning and audio generating means for generating predefined sounds for each identified label. As such a reader device is not limited to a laser based reading head, it may be safer for child usage than traditional reader devices. However, the devices described in U.S. patent application Ser. No. 2006/0259314 are not described as being useable with interchangeable reader device housings and/or reader device accessories.

Another example of a device that provides an interactive layer to a book is disclosed in U.S. Pat. No. 6,763,995, the disclosure of which is incorporated herein by reference. U.S. Pat. No. 6,763,995 describes a method and system for illustrating sound and text comprising a book with pages including illustrations and text, wherein at least some of the pages include magnetic signatures. The system further includes a book holder adapted to accept the book. As such, the book holder has a reading surface with a magnetic signature sensor, a cartridge slot, a reading controller, a speaker, and a power supply. The system also comprises a cartridge adapted to be inserted into the cartridge slot. The cartridge includes stored audio representations related to the illustrations and/or text of the pages. The magnetic signature sensor is predisposed to detect the magnetic signatures on the pages as they are turned by a user viewing the book. Furthermore, the reading controller is adapted to interact with the magnetic signature sensor to determine what page or pages the user is viewing and to retrieve the audio representations of the illustrations and/or text stored on the cartridge corresponding to the page or pages being viewed by the user. Thus, the reading controller reproduces the audible sounds related to the retrieved audio representations through the speaker for listening by the user. Though the patent provides a system for illustrating sound and text, it utilizes a book holder that increases the price of the system and makes it much more complicated for production than a simple system that only comprises a reader device. Moreover, the patent provides a system that is designated to read magnetic signatures from one or more designated books and therefore regular books without magnetic signatures cannot be used. In addition, U.S. Pat. No. 6,763,995 does not describe a hand-held reader device which is used with interchangeable reader device housings and/or reader device accessories.

### SUMMARY OF THE INVENTION

A broad aspect of some embodiments of the invention relates to providing a system for presenting multimedia content in which a single reader device is generic for any number of housings and/or accessories. In an exemplary embodiment of the invention, the reader device adapts its operation based on which housings and/or accessories are removably attached thereto.

In an exemplary embodiment of the invention, the system is comprised of a reader device, at least one multimedia content indicator, and at least one reader device housing or reader device accessory. Optionally, the system includes a computer. In some embodiments of the invention, the at least one multimedia content indicator is a part of an object (e.g. printed matter, movie, game) which is being used in conjunction with system for presenting multimedia content.

In an exemplary embodiment of the invention, a plurality of reader device housings are interchangeable with each other. In some exemplary embodiments of the invention, the reader device housings are adapted to be removably attached to the reader device.

In an exemplary embodiment of the invention, a plurality of reader device accessories are interchangeable with each other. In some exemplary embodiments of the invention, the reader device accessories are adapted to be removably attached to the reader device and/or at least one reader device housing.

In some exemplary embodiments of the invention, at least one reader device housing is used simultaneously with at least one reader device accessory. Optionally, the reader device adapts its operation based on a plurality of housing and/or accessory identifications. Alternatively, the reader device adapts its operation based on one housing or accessory identification.

An aspect of some embodiments of the invention relates to a reader device for presenting multimedia content which adapts its operation depending on which of any number of reader device housings and/or reader device accessories are removably attached thereto.

In an exemplary embodiment of the invention, the reader device comprises at least one sensor. Optionally, the sensor is adapted for sensing the identification of at least one reader device housing and/or at least one reader device accessory in some exemplary embodiments of the invention. Additionally, optionally, and/or alternatively, in some exemplary embodiments of the invention the at least one sensor is adapted to sense at least one multimedia content indicator.

In an exemplary embodiment of the invention, the reader device comprises at least one processor adapted to adapt the operation the reader device based on the reader device housing identification and/or the reader device accessory identification.

In some exemplary embodiments of the invention, the reader device includes at least one of a user control, at least one multimedia content output, a power circuit, a communication interface, a database, and/or a memory.

An aspect of some embodiments of the invention relates to a method of using a system for providing multimedia content which includes a reader device adapted to modify its operation based on which reader device housings and/or reader device accessories are attached thereto.

In an embodiment of the invention, at least one of a reader device housing and/or reader device accessory is removably attached to a reader device, wherein the reader device detects and/or senses and/or receives the identification of the at least one reader device housing and/or reader device accessory and adapts reader device operation as a result. In an embodiment of the invention, a plurality of adaptations of operation of reader device are made as a result of a plurality of reader device housings and/or reader device accessories being used with reader device. In some embodiments of the invention, no changes are made in the operation of the reader device. In some exemplary embodiments of the invention, although a plurality of reader device housings and/or reader device accessories are identified, only one or some are actually used to adapt the operation of the reader device. In an exemplary embodiment of the invention, when a different object with multimedia content is to be used with the reader device, at least one different reader device housing and/or reader device accessory is interchanged with at least one housing and/or accessory already attached to the reader device in order to adapt the operation of the reader device to match the different object.

There is thus provided in accordance with an exemplary embodiment of the invention, a system for presenting multimedia content, comprising: a reader device; at least one of a reader device housing or reader device accessory removably attached to the reader device; and, at least one multimedia content enhanced object with at least one multimedia content indicator; wherein the reader device adapts its operation based on an identification of the at least one reader device housing or reader device accessory removably attached thereto. In an exemplary embodiment of the invention, the system further comprises a computer. Optionally, the reader device is humanoid shaped. Optionally, the reader device is animal shaped. Optionally, the at least one reader device housing is interchangeable with at least one other reader device housing. In an embodiment of the invention, the at least one reader device accessory is interchangeable with at least one other reader device accessory. Optionally, the at least one reader device accessory is removably attached to at least one reader device housing. Optionally, the at least one reader device housing is removably attached to the reader device.

In an exemplary embodiment of the invention, the reader device is adapted to do at least one of: changing a voice presented by the reader device, adjusting to read the at least one multimedia content indicator, or adjusting to play a game with virtual characteristics attributed to the at least one reader device housing's or reader device accessory's identification.

In an embodiment of the invention, the at least one reader housing is humanoid, animal, plant, inanimate object or fictional character shaped. In some embodiments of the invention, the at least one reader accessory is clothing for the reader device or the at least one reader housing. Optionally, the at least one reader device housing or reader device accessory is adapted to provide its identification to the reader device.

In an embodiment of the invention, at least one of the reader device, reader device housing or reader device accessory is adapted to be attached to a memory. Optionally, the memory is a removably attachable memory card. Optionally, the memory is adapted to enhance a specific multimedia content enhanced object.

In an embodiment of the invention, at least one of the reader device, reader device housing or reader device accessory is adapted to enhance a specific multimedia content enhanced object.

There is thus provided in accordance with an embodiment of the invention, a reader device for presenting multimedia content, comprising: at least one sensor for sensing at least one of a reader device housing identification or a reader device accessory identification; and, a processor for adapting the operation of the reader device based on the reader device housing identification or the reader device accessory identification.

In an exemplary embodiment of the invention, the reader device is adapted to have at least one removably attachable reader device housing or reader device accessory attached thereto. Optionally, the reader device is pen, humanoid, animal, plant, inanimate object or fictional character shaped. There is further provided in accordance with an embodiment of the invention, a method of using a system for providing multimedia content, comprising: removably attaching at least one reader device housing or reader device accessory to a reader device; acquiring the identity of the at least one reader device housing or reader device accessory by reader device; adapting operation of the reader device based on the acquired identity of at least one reader device housing or reader device accessory; scanning a multimedia content indicator with the reader device; and, presenting multimedia content to a user. In an exemplary embodiment of the invention, the method further comprises removably attaching at least one replacement reader device housing or reader device accessory to the reader device. Optionally, the provided multimedia content is used for learning. Optionally, the provided multimedia content is used for entertainment. Optionally, the entertainment is a game.

### BRIEF DESCRIPTION OF THE DRAWINGS

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements or parts which appear in more than one figure are generally labeled with a same or similar number in the figures in which they appear, in which:

FIG. 1 is a schematic of a system for providing multimedia content, in accordance with an exemplary embodiment of the invention;

FIG. 2 is a schematic of a reader device, in accordance with an exemplary embodiment of the invention;

FIGS. 3A-3C are perspective views of reader devices, in accordance with exemplary embodiments of the invention;

FIGS. 4A-4B are perspective views of interchangeable reader device housings, in accordance with exemplary embodiments of the invention;

FIGS. 4C-4F are perspective views of interchangeable reader device accessories, in accordance with exemplary embodiment of the invention; and,

FIG. 5 is a flowchart illustrating a method of using a system for providing multimedia content, in accordance with an exemplary embodiment of the invention.

### DETAILED DESCRIPTION OF EXEMPLARY EMBODIMENTS

Embodiments of the present invention comprise and/or are intended to be used with systems for providing multimedia content to traditional media, an example of traditional media being print. It is conceived that a single generic reader device can be used with a plurality of interchangeable reader device housings and/or reader device accessories in order to provide varying multimedia content. In some embodiments of the invention, at least one reader device housing and/or reader device accessory is corresponded with certain related multimedia content and is therefore used with the reader device when that certain related multimedia content is to be presented.

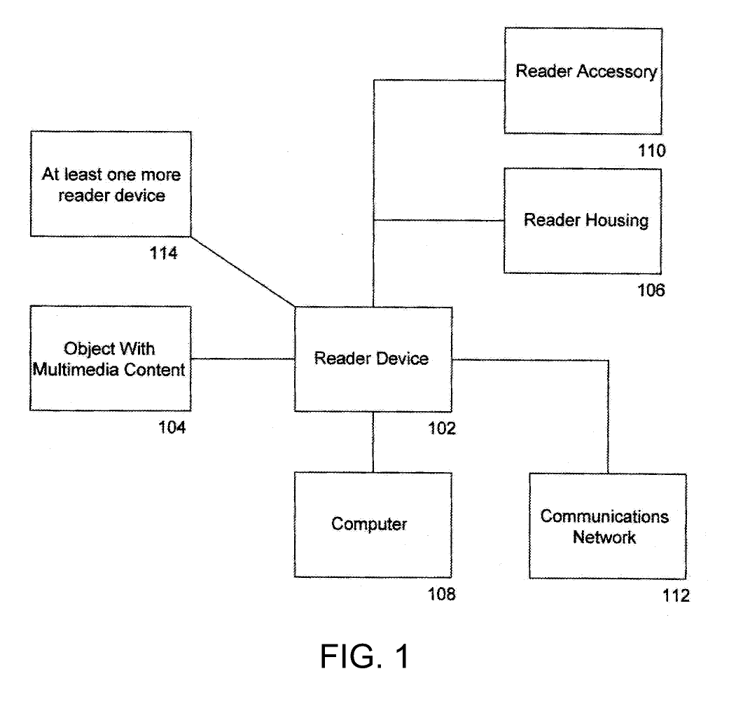

A system 100 for providing multimedia content is shown in FIG. 1, in accordance with an exemplary embodiment of the invention. In an exemplary embodiment of the invention, a reader device 102 is used to detect and/or read a multimedia content indicator 104 located on or in proximity to the traditional media.

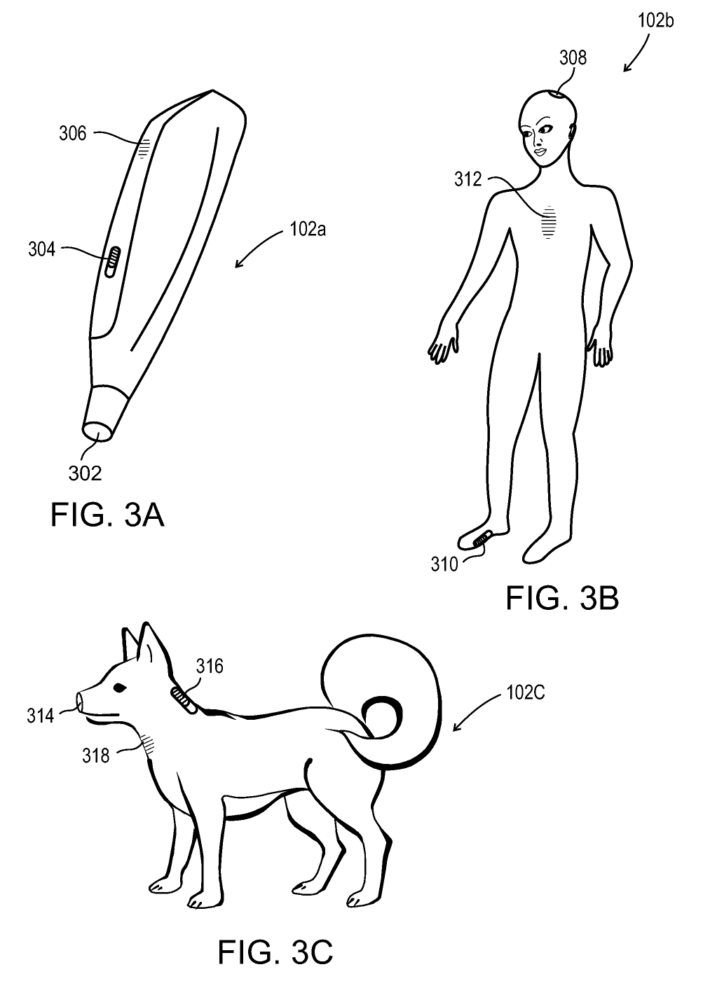

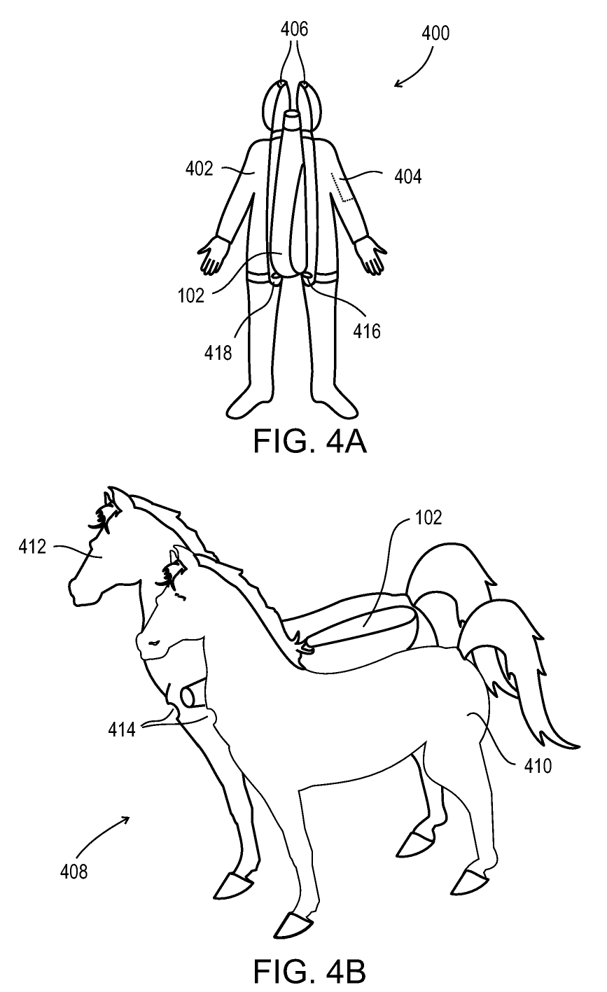

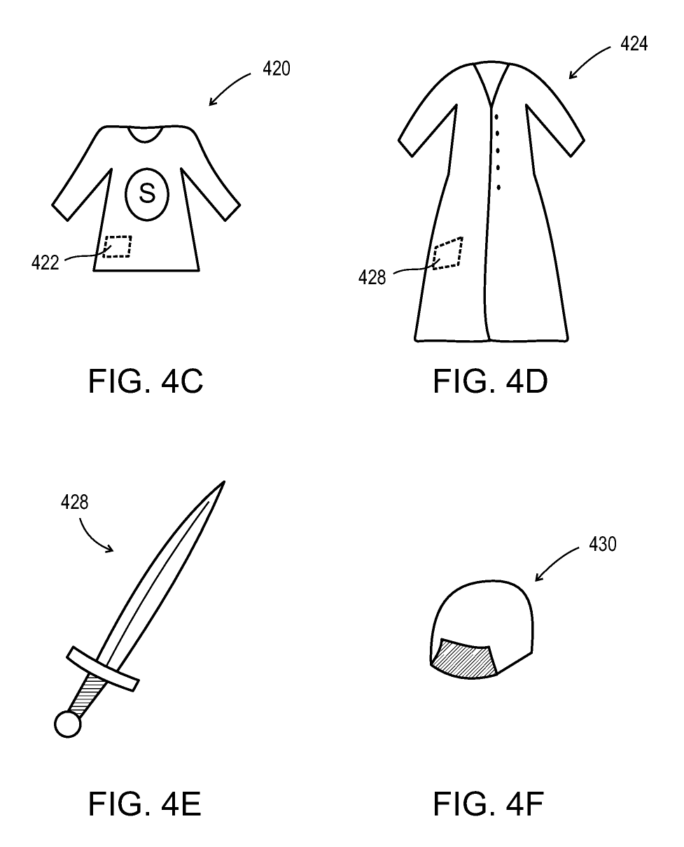

Exemplary reader devices are described and shown with respect to FIGS. 3A-3C, inter alia. Reader device 102 is used in conjunction with at least one reader housing 106 and/or reader accessory 110, in some exemplary embodiments of the invention. Illustrative reader housings 106 and reader accessories 110 are shown and described in more detail with respect to FIGS. 4A-4F, inter alia.

In some embodiments of the invention, at least one reader housing 106 and/or reader accessory 110 signals to reader device 102 its identity, and/or reader device 102 detects the at least one reader housing's 106 and/or accessory's identity, prompting reader device 102 to adapt its multimedia content presentation to a setting which matches the at least one reader housing 106 and/or reader accessory 110 identity. For example, if reader accessory 110 is an article of clothing like a dress, reader device 102 assumes a female voice. As another example, if reader housing 106 is an identifiable non-fictional or fictional character's shape and/or appearance (e.g. Superman®, Elmo from Sesame Street®) then reader device 102 detects the reader housing's 106 identity and adapts its multimedia content to match that character's voice. It should be understood that adaptation of reader device 102 to change the voice presented by reader device 102 is but one way of adapting its operation based on the detected identity of the at least one reader housing 106 and/or reader accessory 110. Additional, but not exclusive, examples of adapted reader device 102 operation include adjusting to read specific multimedia content indicators 104, adjusting to read a multimedia content indicators 104 from one or more types of traditional media, adjusting reader device 102 to play a game with the virtual characteristics and/or abilities attributed to the at least one reader housing's 106 and/or reader accessory's 110 identity.

In some embodiments of the invention, system 100 optionally includes a computer 108 and/or a communications network 112, for example the internet. Communication between reader device 100, multimedia content indicators 104, reader housings 106, reader accessories 110 and/or computer 108 and/or communications network 112 are of any methodology and/or technology known in the art, in particular wireless methodologies. In an embodiment of the invention, at least one more reader device 114 is used in conjunction with reader device 102. In some embodiments of the invention, a combination of a plurality of reader devices 102, 114 and/or reader device housings 106 and/or reader device accessories 110 determines what multimedia content is presented.

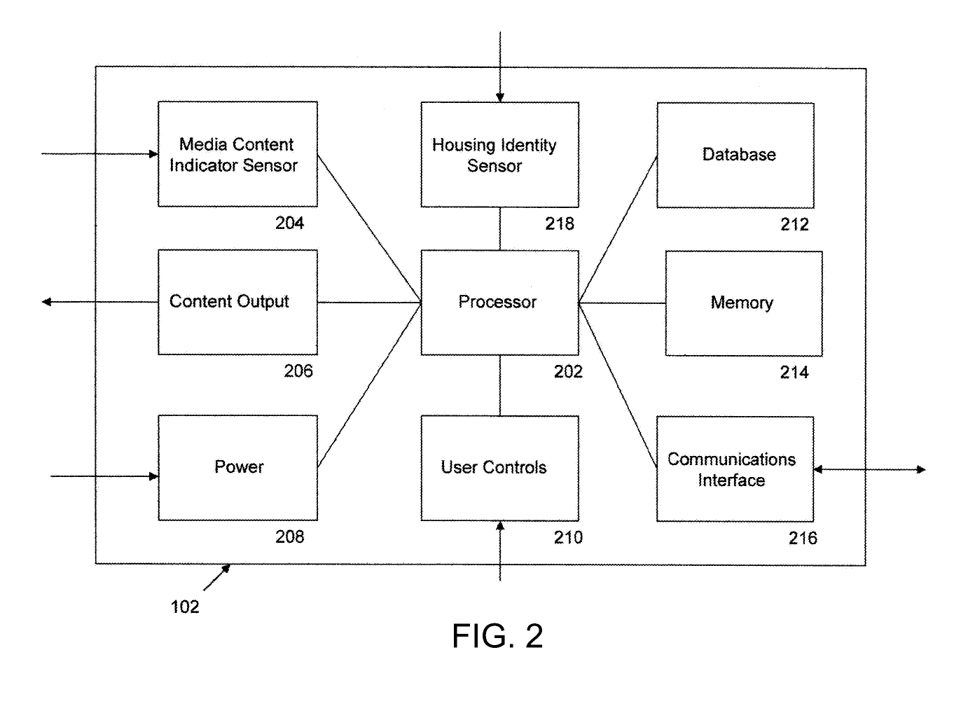

Referring to FIG. 2, a schematic diagram of reader device 102 is shown, in accordance with an exemplary embodiment of the invention. Reader device 102 is comprised of at least some of a processor 202, various sensors 204, 218, at least one user control 210, at least one multimedia content output 206, a power circuit 208, a communication interface 216, a database 212, and/or a memory 214, in an exemplary embodiment of the invention.

In operation, reader device 102 uses a multimedia content indicator sensor 204 to detect the presence of multimedia content indicator 104. Processor 202, connected operationally to multimedia content indicator sensor 204 and/or to database 212 and/or to memory 214 and/or optionally to computer 208 via communication interface 216, identifies the specific multimedia content which is to be presented to the user based on the multimedia content indicator 104 sensed by sensor 204. For example, processor 202 compares the sensed multimedia content indicator 104 to a lookup table stored in database 212 and/or on computer 208 in order to determine the multimedia content which is to be presented to the user via at least one multimedia content output 206. In some embodiments of the invention, reader device 102 database 212 is updated periodically to add and/or delete and/or modify data. Optionally, updates occur via communication interface 216. It should be understood that multimedia content output 206 is optionally any of an audio speaker, a visual display, reader device 102 itself (e.g. it moves and/or vibrates) and/or by any device or methodology known in the art.

At least one user control 210 is provided to reader device 102 for controlling at least one aspect of reader device's 102 operation, in an exemplary embodiment of the invention. For example, at least one user control 210 is a button, switch, microphone (i.e. reader device 102 responds to audio commands), a pressure sensor, and/or by any device or methodology for user control known in the art. In an embodiment of the invention, at least one user control 210 is used for controlling reader device 102 volume, on/off condition, manually initiating sensing of multimedia content indicator 104, manually initiating sensing at least one reader device housing 106 and/or accessory 110 identity, as examples.

In an embodiment of the invention, reader device 102 is provided with a reader housing identity sensor 218. In practice, any one of a number of interchangeable reader device housings 106 and/or accessories 110 are placed on reader device 102 and reader housing identity sensor 218 detects which reader device housing 106 and/or accessory 110 has been placed on reader device 102. Processor 202, connected operationally to reader housing identity sensor 218 and/or to database 212 and/or to memory 214 and/or optionally to computer 108 via communication interface 216, identifies the at least one specific reader housing 106 and/or reader accessory 110 which is removably attached to reader device 102 and therefore can determine (e.g. using a lookup table) what multimedia content is to be presented to the user based on the reader housing identity sensed by sensor 218, in an exemplary embodiment of the invention. Optionally, multimedia content indicator sensor 204 and reader housing identity sensor 218 are the same element, in an embodiment of the invention.

In some embodiments of the invention, computer 208 and/or reader device 102 are connected to communications network 112 via communication interface 216. In an embodiment of the invention, multimedia content is retrieved from communications network 112 according to identified reader housings 106 and/or reader accessories 110. In an embodiment of the invention, multimedia content is retrieved from computer 208 according to identified reader housings 106 and/or reader accessories 110. In some embodiments of the invention, computer 208 launches a computer program and/or performs operational commands and/or adapts its operation according to identified reader housings 106 and/or reader accessories 110. For example, based on the identification of a particular reader housing 106 and/or reader accessory 110, computer 208 launches a program stored on computer 208 which is related to the identified reader housing 106 and/or reader accessory 110.

In an embodiment of the invention, at least one reader housing 106 and/or reader accessory 110 is provided with a memory. Optionally, the memory is removably attachable to the at least one reader housing 106 and/or reader accessory 110. In some embodiments, the removably attachable memory is adapted to be in the form of a memory card. Optionally, the shape of the memory card is standard and reader device 102, the at least one reader housing 106 and/or reader accessory 110 are adapted to be removably attached to and/or read any one of a number of memory cards. The memory holds content relevant to the at least one reader housing 106 and/or reader accessory 110, for example settings, in an exemplary embodiment of the invention. In some embodiments of the invention, the memory of the at least one reader housing 106 and/or reader accessory 110 and/or memory 214 and/or database 212 are updated from communications network 112 and/or computer 108. Optionally, the memory of the at least one reader housing 106 and/or reader accessory 110 and/or memory 214 and/or database 212 communicate data with each other. In an exemplary embodiment of the invention, reading device 102 senses and/or detects and/or receives at least one reader device housing 106 and/or accessory 110 identity using a wireless and/or physical connection. In some wireless embodiments of the invention, infrared (“IR”), optical, Bluetooth®, radio, laser, RFID, transponder, barcode, colored label technologies and/or any device or methodology known in the art are used by reader device 102 to detect and/or sense and/or receive at least one reader device housing 106 and/or accessory 110 identity.

In some physical connection embodiments of the invention, pins and/or projections and/or printed conductors and/or printed resistors and/or micro switches and/or any device or methodology known in the art are used to encode reader device housing 106 and/or accessory 110 identity, which is then read by reader housing identity sensor 218 as a result of physical contact when reader housing 206 is removably affixed to reader device 102.

As described in an example above, the housing of a particular character could be identified and subsequently, reader device 102 could present multimedia content affiliated with that particular character. In this manner, a standard reader device 102 is used in combination with a variety of interchangeable reader housings 106 and/or reader accessories 110 which are exchanged and/or removably affixed to reader device 102, in accordance with an exemplary embodiment of the invention.

In an embodiment of the invention, at least one reader housing 106 and/or reader accessory 110 is provided with an internal power source. In some embodiments of the invention, at least one reader housing 106 and/or reader accessory 110 is powered by reader device 102.

Referring to FIGS. 3A-3C, exemplary reader devices 102a, 102b, and 102c are shown, in accordance with some exemplary embodiments of the invention. It should be understood that these reader devices 102a, 102b, and 102c are by way of example only and that virtually any shape can be imparted to reader device 102 for use with system 100. FIG. 3A shows a pen-shaped reader device 102a which is adapted to be grasped and operated in one hand of a user, in an embodiment of the invention. Reader device 102a is optionally similar to reader devices shown and described in International Patent Application Serial No. IL2008/000324 filed on Mar. 10, 2008, which is incorporated herein by reference, for example with a multimedia content indicator sensor 302, a user control 304 and/or a multimedia content output 306, with additional features and/or capabilities as described and/or suggested herein. In some embodiments of the invention, reader device 102a is adapted to be removably affixed to interchangeable housings 106, such as those described with respect to FIGS. 4A-4B and/or interchangeable reader device accessories 110 such as those shown and described in more detail with respect to FIGS. 4C-4F.

FIG. 3B shows a humanoid shaped reader device 102b, in accordance with an exemplary embodiment of the invention. Reader device 102b optionally is formed with a female figure, in some exemplary embodiments of the invention. Reader device 102b is optionally formed with a male figure, in some embodiments of the invention. It should be understood that in some exemplary embodiments of the invention, various physiques for reader device 102b are possible, depending on their intended use (e.g. superhero, Barbie® doll, Elmo® character). In some embodiments of the invention, reader device 102b is adapted for use with interchangeable housings 106, such as those described with respect to FIGS. 4A-4B and/or interchangeable reader device accessories 110 such as those shown and described in more detail with respect to FIGS. 4C-4F. An animal shaped reader device 102c is shown in FIG. 3C, in accordance with an exemplary embodiment of the invention. Reader device 102c is shown to demonstrate additional reader device 102 possibilities and is optionally used in a similar fashion to reader devices 102a, 102b, in some exemplary embodiments of the invention. Reader devices 102b, 102c are also provided with multimedia content indicator sensors 308, 314, user controls 310, 316 and/or multimedia content output 312, 318, in some exemplary embodiments of the invention.

While exemplary pen, humanoid and animal shaped reader devices are shown and described with respect to FIGS. 3A-3C, it should be understood that reader device 102 can take virtually any shape, including fictional characters (i.e. may not necessarily be humanoid), plant life and/or inanimate objects. For example, the reader device could be shaped like a weapon, a mode of transportation, a consumer appliance or electronic device, and/or a communications device.

FIGS. 4A-4B show interchangeable reader device housings 400, 408, in accordance with exemplary embodiments of the invention. In an embodiment of the invention, reader device housing 400, 408 are adapted to be used within system 100. Reader device housings 106, of which housings 400, 408 are examples, are adapted to be removably affixed to reader device 102, of which reader device 102a is an example, in some exemplary embodiments of the invention. In an embodiment of the invention, a single reader device 102 is altered in shape by removably affixing a reader housing 106 thereto.

FIG. 4A shows a reader housing 400 which is humanoid in shape. In an embodiment of the invention, reader housing 400 is comprised of two parts 402, 404 which are adapted to encase reader device 102 but still allow its operation, for example identifying multimedia content indicators 104, optionally via an aperture 406, turning reader device 102 on/off, conveying multimedia content to the user via at least one multimedia content output and/or adjusting volume of output multimedia content. Parts 402, 404 are removably attached using counterparts 416, 418, for example snaps, Velcro®, projections and receiving holes and/or any other methodology and device known to those skilled in the art, in accordance with some exemplary embodiments of the invention.

FIG. 4B shows an interchangeable reader device housing 408 which has the shape of an animal. In an embodiment of the invention, animal reader device housing 408 is divided into two halves, 410, 412 which are adapted to be removably attached to each other and/or reader device 102. As with the humanoid reader device housing 400, animal reader device housing 408 is adapted to allow for operation of reader device 102 despite being housed in reader device housing 408, for example by providing an aperture for the at least one sensor of reader device 102.

In some exemplary embodiments of the invention, reader device 102 is placed into a fitted enclosure within reader device housing 106 adapted for receipt and temporary attachment of reader device 102 without using two counterpart halves, such as shown in FIGS. 4A-4B.

FIGS. 4C-4D show interchangeable reader device accessories 420, 424, in accordance with exemplary embodiments of the invention. In some embodiments of the invention, reader device accessories 420, 424 are adapted to be placed on a reader device, for example humanoid reader device 102b. Optionally, in some embodiments of the invention reader device accessories are used similarly to the way clothing is used for a doll: to enhance the appearance of the reader device and/or to create a setting for the media being used with reader device 102, for example.

FIG. 4C shows a reader device accessory 420 which is the shirt of a superhero's costume, in an exemplary embodiment of the invention. Reader device accessory 420 is adapted to operate within system 100, for example by working in conjunction with at least reader device 102 to provide reader device accessory 420 identification to system 100. In an embodiment of the invention, a microchip 422 is embedded in reader device accessory 420, for storing and/or identifying reader device accessory 420 to reader device 102. In an exemplary embodiment of the invention, when reader device accessory 420 is placed on humanoid reader device 102b (or reader 102a with reader device housing 400 attached), reader device 102b identifies reader device accessory 420 and adapts reader device 102b operation to match the superhero associated with reader device accessory 420, for example using the superhero's voice.

FIG. 4D shows a reader device accessory 424 which is a dress, in an exemplary embodiment of the invention. Reader device accessory 424 is embedded with an identification device 426 which is adapted to provide reader device 102 and system 100 with the identification of reader device accessory 424 so that the operation of reader device 102 can be adapted based on the identity of reader device accessory 424. In an exemplary embodiment of the invention, reader device 102 would assume a female's voice based on the fact that it was “wearing” a dress, as identified by system 100 and/or reader device 102.

FIGS. 4E and 4F show exemplary reader device accessories 110 including a sword 428 and a helmet 430. As with other accessories 110 described herein, removably attaching sword 428 and/or helmet 430 to a reader device optionally causes the reader device to adapt its operation in accordance with at least one setting associated with the attached accessory. It should be noted that although clothes and/or weapons are described herein as exemplary reader device accessories 110, it is conceived that any object which could enhance the presentation of multimedia content is adaptable for use with reader device 102 as an accessory.

It should be understood that system 100 is adapted for use with at least one layer of housing and/or accessory for reader device 102, in an embodiment of the invention. This includes the potential for multiple layers of housing and/or accessory, for example reader device 102a having thereon reader device housing 400, reader device housing 400 having thereon reading device accessory 420, in accordance with an exemplary embodiment of the invention. Use of multiple layers allow for multiple modification of the behavior of reading device 102 by layering at least one housing and/or at least one accessory, in some embodiments of the invention. In some embodiments of the invention, use of multiple layers does not necessarily translate to multiple modifications to reader device's 102 behavior, for example where only one of either a housing 106 or an accessory 110 is used exclusively by reader device in adapting its operation. To illustrate system's 100 ability to adapt its operation based on different reader device housings 106 and reader device accessories 110, in an exemplary embodiment of the invention, a reader device 102a with a Superman® shaped reader device housing 106 is used with a “Clark Kent” outfit as a reader device accessory 110 on top of the Superman® shaped reader device housing 106. Reader device 102a detects both reader device housing 106 identification and reader device accessory 110 identification using at least one sensor 218 in order to adapt its operation. In this exemplary embodiment of the invention, processor 202 determines (in an embodiment of the invention, by accessing database 212) that as long as the Clark Kent reader device accessory 110 is attached on the Superman® reader device housing 106, then the reader device 102a should be operating with the voice and other characteristics of Superman's alter ego, Clark Kent. In an embodiment of the invention, when the Clark Kent reader device accessory 110 is removed from the Superman® reader device housing 106, then when multimedia content is presented by reader device 102a the Superman® persona is presented to user.

In an embodiment of the invention, reader device 102, at least one reader housing 106 and/or at least one reader accessory 110 is adapted to enhance a specific media object, for example a specific Superman® shaped reader housing 106 adapted to enhance a corresponding Superman® book. In some embodiments of the invention, a removably attachable memory, such as those described herein, is provided with details and/or settings specific to a certain multimedia enhanced object which may or may not be sold together with the multimedia enhanced object and/or a reader device 102, at least one reader housing 106 and/or at least one reader accessory 110.

In an embodiment of the invention, a plurality of reader devices is used in combination for providing multimedia content. In some embodiments of the invention, the plurality of reader devices is used with at least one reader device housing 106 and/or reader device accessory 110. Optionally, at least one reader device housing 106 and/or reader device accessory 110 from each of the plurality of reader devices contributes to the presentation of multimedia content. In an embodiment of the invention, at least one of the plurality of reader devices is provided with a sensor and/or is adapted for detecting at least one other of the plurality of reader devices and presenting multimedia content pursuant to the detection. Optionally, at least one of the plurality of reader devices is adapted to detect at least one reader device housing 106 and/or reader device accessory 110 on at least one other of the plurality of reader devices and/or present multimedia content pursuant to the detection.

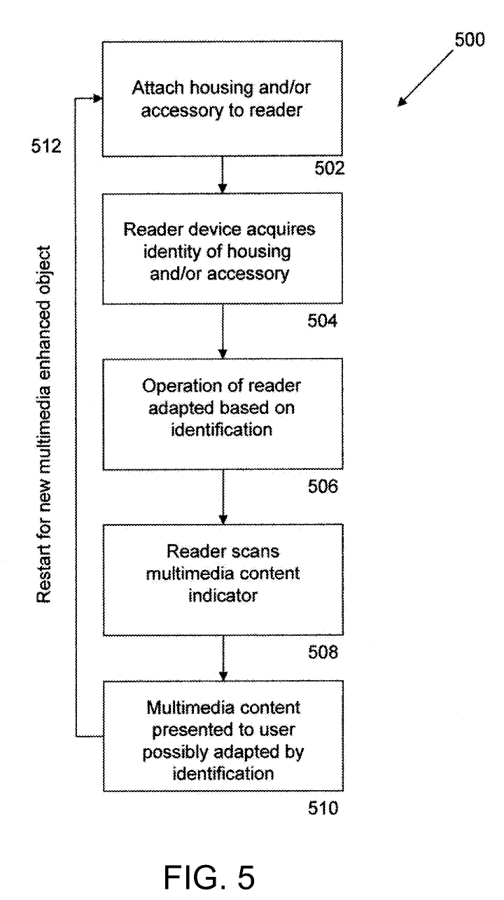

FIG. 5 shows a flowchart 500 illustrating a method of using system 100 for providing multimedia content, in accordance with an exemplary embodiment of the invention. As described herein, at least one reader device housing 106 and/or reader device accessory 110 is removably attached (502) to a reader device 102, for example any of the reader devices 102a, 102b or 102c, in accordance with an embodiment of the invention. In an exemplary embodiment of the invention, reader device 102 acquires (504) the identity of the at least one reader device housing 106 and/or reader device accessory 110 by sensing and/or detecting and/or receiving and/or by any means known in the art. As described above, in an embodiment of the invention, operation of reader device 102 is adapted (506) based on the acquired (504) identity of at least one reader device housing 106 and/or reader device accessory 110. In an exemplary embodiment of the invention, multimedia content indicator 104 is scanned (508) by reader device 102 and multimedia content, possibly (it is conceived that in some embodiments of the invention some or no multimedia content will change even though at least one new housing 106 and/or accessory 110 is being used) adapted (506) by the at least one reader device housing 106 and/or reader device accessory 110, is presented (510) to the user. In an embodiment of the invention, when a different multimedia content enhanced object is to be used by user, at least one new and/or different and/or replacement reader device housing 106 and/or reader device accessory 110 is removably attached (502) to a reader device 102, restarting (512) the method of using system 100.

In an embodiment of the invention, reader device 102 is adapted to be used in conjunction with a game which is enhanced with multimedia content. Optionally, reader device housing 106 and/or at least one reader device accessory 110 is used with reader device 102 in the context of the game. In some embodiments of the invention, reader device 102 communicates and/or interacts with other objects, such as other reader devices and/or housings and/or accessories, in the context of the game, for example in a free-for-all, as adversaries or teammates. In some embodiments of the invention, a participating reader device is bestowed abilities and/or characteristics which are a part of the game being played by removably attaching a housing and/or at least one accessory and/or a memory card.

It will be appreciated that the above described methods of using system 100 may be varied in many ways, including, omitting or adding steps, changing the order of steps and the types of devices used. In addition, a multiplicity of various features, both of method and of devices have been described. In some embodiments mainly methods are described; however, also apparatus adapted for performing the methods are considered to be within the scope of the invention. It should be appreciated that different features may be combined in different ways. In particular, not all the features shown above in a particular embodiment are necessary in every similar embodiment of the invention. Further, combinations of the above features are also considered to be within the scope of some embodiments of the invention. Also, within the scope of the invention is firmware, hardware, software and computer readable-media including software which is used for carrying out and/or guiding the methodologies described herein, particularly with respect to presenting multimedia content to a user and/or the operation of devices and/or accessories and/or housings for presenting multimedia content. Hardware optionally includes a computer, the computer optionally comprising a processor, memory, storage space and software loaded thereon.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. When used in the following claims, the terms “comprises”, “includes”, “have” and their conjugates mean “including but not limited to”. The scope of the invention is limited only by the following claims.

What is claimed is:

1. A system for presenting multimedia content, comprising:
a reader device;
at least one of a reader device housing or a reader device accessory removably attached to the reader device; and,
at least one multimedia content enhanced object with at least one multimedia content indicator;
wherein the reader device adapts its operation based on an identification of the at least one reader device housing or reader device accessory removably attached thereto.

2. A system according to claim 1, further comprising a computer.

3. A system according to claim 1, wherein the reader device is humanoid shaped.

4. A system according to claim 1, wherein the reader device is animal shaped.

5. A system according to claim 1, wherein the at least one reader device housing is interchangeable with at least one other reader device housing.

6. A system according to claim 1, wherein the at least one reader device accessory is interchangeable with at least one other reader device accessory.

7. A system according to claim 1, wherein the at least one reader device accessory is removably attached to at least one reader device housing.

8. A system according to claim 7, wherein the at least one reader device housing is removably attached to the reader device.

9. A system according to claim 1, wherein the reader device is adapted to do at least one of: changing a voice presented by the reader device, adjusting to read the at least one multimedia content indicator, or adjusting to play a game with virtual characteristics attributed to the at least one reader device housing's or reader device accessory's identification.

10. A system according to claim 1, wherein the at least one reader housing is humanoid, animal, plant, inanimate object or fictional character shaped.

11. A system according to claim 1, wherein the at least one reader accessory is clothing for the reader device or the at least one reader housing.

12. A system according to claim 1, wherein the at least one reader device housing or reader device accessory is adapted to provide its identification to the reader device.

13. A system according to claim 1, wherein at least one of the reader device, reader device housing or reader device accessory is adapted to be attached to a memory.

14. A system according to claim 13, wherein the memory is a removably attachable memory card.

15. A system according to claim 13, wherein the memory is adapted to enhance a specific multimedia content enhanced object.

16. A system according to claim 1, wherein at least one of the reader device, reader device housing or reader device accessory is adapted to enhance a specific multimedia content enhanced object.

17. A reader device for presenting multimedia content, comprising:
at least one sensor for sensing at least one of a reader device housing identification or a reader device accessory identification; and,
a processor for adapting the operation of the reader device based on the reader device housing identification or the reader device accessory identification.

18. A reader device according to claim 17, wherein the reader device is adapted to have at least one removably attachable reader device housing or reader device accessory attached thereto.

19. A reader device according to claim 17, wherein the reader device is pen, humanoid, animal, plant, inanimate object or fictional character shaped.

20. A method of using a system for providing multimedia content, comprising:
removably attaching at least one reader device housing or reader device accessory to a reader device;
acquiring the identity of the at least one reader device housing or reader device accessory by reader device;
adapting operation of the reader device based on the acquired identity of at least one reader device housing or reader device accessory;
scanning a multimedia content indicator with the reader device; and,
presenting multimedia content to a user.

21. A method according to claim 20, further comprising removably attaching at least one replacement reader device housing or reader device accessory to the reader device.

22. A method according to claim 20, wherein the provided multimedia content is used for learning.

23. A method according to claim 20, wherein the provided multimedia content is used for entertainment.

24. A method according to claim 20, wherein the entertainment is a game.
